(19) United States
(12) Patent Application Publication
(10) Pub. No.: US 2018/0285917 A1
(43) Pub. Date: Oct. 4, 2018

(54) MARKETING ENHANCEMENT METHODS AND SYSTEMS

(71) Applicant: Ronald M. Prupis, Sunrise, FL (US)

(72) Inventor: Ronald M. Prupis, Sunrise, FL (US)

(21) Appl. No.: 15/936,531

(22) Filed: Mar. 27, 2018

Related U.S. Application Data
(60) Provisional application No. 62/629,960, filed on Feb. 13, 2018.
(60) Provisional application No. 62/551,863, filed on Aug. 30, 2017.
(60) Provisional application No. 62/477,987, filed on Mar. 28, 2017.

(51) Int. Cl. G06Q 30/02

(52) U.S. Cl. CPC G06Q 30/0236; G06Q 30/0267; G06Q 30/0239

(57) ABSTRACT

A method includes providing advertising material to a target, where the material is inclusive of a code adapted to initiate a computer implemented beneficial service and receiving identifying information about the target, upon registration with the beneficial service by the target. The beneficial service may be a third-party beneficial service and a third-party beneficial service provider also receives the identifying information. In another aspect a method includes providing advertising material to a target, the material being inclusive of a code linked to a computer implemented coupon service, the coupon service being adapted to permit the target to register therewith by providing identifying information to a provider of the coupon service; automatically receiving the target's identifying information upon registration with the coupon service by the target; and providing the target with a first coupon inclusive of a financial benefit for providing the identifying information to the coupon service.

### CROSS-REFERENCE TO RELATED APPLICATIONS

The present application claims benefit of U.S. Provisional Patent Application Ser. No. 62/477,987 filed Mar. 28, 2017, U.S. Provisional Patent Application Ser. No. 62/551/863 filed Aug. 30, 2017, and U.S. Provisional Patent Application Ser. No. 62/629,960 filed Feb. 13, 2018, all entitled “MARKETING ENHANCEMENT METHODS AND SYSTEMS,” the disclosures of which are hereby incorporated by reference herein.

### BACKGROUND OF THE INVENTION

The present invention relates to methods and systems to enhance business marketing efforts. Present methods for marketing business endeavors include advertisements. These include traditional advertisements in print, television, radio, virtual and the like. Also included are advertisements via restaurant placemats or menus. A more personal method of advertising is through the furnishing of business cards, physical or virtual (i.e. electronic), or printed promotional materials such as mugs, clothing, water bottles, bags, and the like.

### BRIEF SUMMARY OF THE INVENTION

Although each of these methods has been well received, there is a deficiency in advertiser appreciating the effectiveness of such endeavors. Specifically, it is very difficult for an advertiser to ascertain how many people (“targets”) have (a) actually seen the advertisement, (b) appreciated the content of the advertisement, and (c) acted on the advertisement. The present MARKETING ENHANCEMENT METHODS AND SYSTEMS are adapted to alleviate these problems.

Under these methods and systems, an advertiser obtains direct feedback of “successful” advertisements. In some embodiments, the advertiser can obtain information on all aspects (a), (b), and (c). In others, they can obtain exact information as to (c) which can be used to more accurately surmise the results of elements (a) and (b) than prior advertisement methods.

Importantly, knowledge of (c), those targets whom have acted on the advertisement, comes complete with identifying information for the target, or at least makes such information readily available to the advertiser. Alternatively, or in addition, a third-party providing beneficial services to the target will also obtain the identifying information. In preferred embodiments, the third-party first receives the identifying information which may then be transferred to the advertiser.

The identifying information is preferably at least the name and email address of the target. Additional information such as full mailing address, zip code, gender, age range, or exact age may also be obtained. Other possible items of information include income range or exact income. Any of these items of identifying information may be provided, and any combination of the items of identifying information may be provided.

Representative examples of the identifying information are therefore:

Example 1: Name, email address, and full mailing address.

Example 2: Name, email address, and zip code.

Example 3: Name, email address, and gender.

Example 4: Name, email address, and age.

Example 5: Name, email address, full mailing address, and income.

Example 6: Name and full mailing address.

Example 7: Name, email address, and gender.

Example 8: Email address.

Example 9: Gender and age.

Example 10: Zip code and income range.

In accordance with one embodiment of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target.

In a further aspect of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target, wherein the computer implemented beneficial service is a third-party beneficial service and a third-party beneficial service provider also receives the identifying information.

In a further aspect of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target, wherein the code is a bar code or QR code.

In a further aspect of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target, wherein the identifying information includes the target's name and email address.

In a further aspect of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target, wherein the beneficial service is a coupon service.

In a further aspect of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target, wherein the beneficial service is a coupon service, and wherein the coupon service provides coupons for one of restaurants, theaters, attractions, and services.

In a further aspect of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target, wherein the advertising material is virtual advertising material.

In a further aspect of the invention, there is provided a marketing enhancement method comprising providing advertising material to a target, where the advertising material is inclusive of a code adapted to initiate a computer implemented beneficial service; and receiving identifying information about the target, including at least a name and email address, upon registration with the computer implemented beneficial service by the target, wherein the advertising material is virtual advertising material, where the virtual advertising material is a virtual business card.

In a further aspect of the invention, there is provided a marketing enhancement method comprising providing advertising material in the form of a business card to a target, the advertising material being inclusive of a code linked to a computer implemented coupon service, the computer implemented coupon service being adapted to permit the target to register therewith by providing identifying information to a provider of the computer implemented coupon service; automatically receiving the target's identifying information upon registration with the computer implemented coupon service by the target; and providing the target with a first coupon inclusive of a financial benefit for providing the identifying information to the computer implemented coupon service.

In a further aspect of the invention, there is provided a marketing enhancement method comprising providing advertising material in the form of a business card to a target, the advertising material being inclusive of a code linked to a computer implemented coupon service, the computer implemented coupon service being adapted to permit the target to register therewith by providing identifying information to a provider of the computer implemented coupon service; automatically receiving the target's identifying information upon registration with the computer implemented coupon service by the target; and providing the target with a first coupon inclusive of a financial benefit for providing the identifying information to the computer implemented coupon service; the method further comprising permitting the target to add financially to the first coupon.

In a further aspect of the invention, there is provided a marketing enhancement method comprising providing advertising material in the form of a business card to a target, the advertising material being inclusive of a code linked to a computer implemented coupon service, the computer implemented coupon service being adapted to permit the target to register therewith by providing identifying information to a provider of the computer implemented coupon service; automatically receiving the target's identifying information upon registration with the computer implemented coupon service by the target; and providing the target with a first coupon inclusive of a financial benefit for providing the identifying information to the computer implemented coupon service; wherein the business card is a virtual business card.

In a further aspect of the invention, there is provided a marketing enhancement method comprising providing advertising material in the form of a business card to a target, the advertising material being inclusive of a code linked to a computer implemented coupon service, the computer implemented coupon service being adapted to permit the target to register therewith by providing identifying information to a provider of the computer implemented coupon service; automatically receiving the target's identifying information upon registration with the computer implemented coupon service by the target; and providing the target with a first coupon inclusive of a financial benefit for providing the identifying information to the computer implemented coupon service; wherein the previously unavailable coupons are made available under a different financial scheme from the first coupon.

In a further aspect of the invention, there is provided a marketing enhancement method comprising providing advertising material in the form of a business card to a target, the advertising material being inclusive of a code linked to a computer implemented coupon service, the computer implemented coupon service being adapted to permit the target to register therewith by providing identifying information to a provider of the computer implemented coupon service; automatically receiving the target's identifying information upon registration with the computer implemented coupon service by the target; and providing the target with a first coupon inclusive of a financial benefit for providing the identifying information to the computer implemented coupon service; wherein the coupon service provides coupons for one of restaurants, theaters, attractions, and services.

In a further aspect of the invention, there is provided a marketing enhancement method comprising providing advertising material in the form of a business card co a target, the advertising material being inclusive of a code linked to a computer implemented coupon service, the computer implemented coupon service being adapted to permit the target to register therewith by providing identifying information to a provider of the computer implemented coupon service; automatically receiving the target's identifying information upon registration with the computer implemented coupon service by the target; and providing the target with a first coupon inclusive of a financial benefit for providing the identifying information to the computer implemented coupon service; wherein the identifying information includes at least a name and email address of the target.

In a further aspect of the invention there is provided a marketing enhancement system comprising advertising material distributed by an advertiser and viewable by a target, where the advertising material is inclusive of a code operable to initiate a computer implemented beneficial service for registration by the target; and a computer readable medium associated with the computer implement eel beneficial service, the computer readable medium comprising stored electronic data including, upon registration with the computer implemented coupon service by the target, identifying information about the target; wherein the advertiser and an operator of the computer implemented coupon service receive the identifying information about the target.

In a further aspect of the invention there is provided a marketing enhancement system comprising advertising material distributed by an advertiser and viewable by a target, where the advertising material is inclusive of a code operable to initiate a computer implemented beneficial service for registration by the target; and a computer readable medium associated with the computer implemented beneficial service, the computer readable medium comprising stored electronic data including upon registration with the computer implemented coupon service by the target identifying information about the target; wherein the advertiser and. an operator of the computer implemented coupon service receive the identifying information about the target; and wherein the beneficial service is coupon service.

In a further aspect of the invention there is provided a marketing enhancement system comprising advertising material distributed by an advertiser and viewable by a target, where the advertising material is inclusive of a code operable to initiate a computer implemented beneficial service for registration by the target; and a computer readable medium associated with the computer implemented beneficial service, the computer readable medium comprising stored electronic data including, upon registration with the computer implemented coupon service by the target, identifying information about the target; wherein the advertiser and an operator of the computer implemented coupon service receive the identifying information about the target; and wherein the business card is a virtual, business card.

In a further aspect of the invention there is provided a marketing enhancement system comprising advertising material distributed by an advertiser and viewable by a target, where the advertising material is inclusive of a code operable to initiate a computer implemented beneficial service for registration by the target; and a computer readable medium associated with the computer implemented beneficial service, the computer readable medium comprising stored electronic data including, upon registration with the computer implemented coupon service by the target, identifying information about the target; wherein the advertiser and an operator of the computer implemented coupon service receive the identifying information about the target; and wherein the identifying information includes at least name and email address.

In a further aspect of the invention there is provided a marketing enhancement system comprising advertising material distributed by an advertiser and viewable by a target, where the advertising material is inclusive of a code operable to initiate a computer implemented beneficial service for registration by the target; and a computer readable medium associated with the computer implemented beneficial service, the computer readable medium comprising stored electronic data including, upon registration with, the computer implemented coupon service by the identifying information about the target; wherein the advertiser and an operator of the computer implemented coupon service receive the identifying information about the target; and wherein the identifying information includes a mailing address.

In a further aspect of the invention there is provided a marketing enhancement system comprising advertising material distributed by an advertiser and viewable by a target, where the advertising material is inclusive of a code operable to initiate a computer implemented beneficial service for registration by the target; and a computer readable medium associated with the computer implemented beneficial service, the computer readable medium comprising stored electronic data including, upon registration with the computer implemented coupon service by the target, identifying information about the target; wherein the advertiser and an operator of the computer implemented coupon service receive the identifying information about the target; and wherein the coupon service provides coupons for one of restaurants, theatres attractions, and services.

### DETAILED DESCRIPTION

In the following are described embodiments of the MARKETING ENHANCEMENT METHODS AND SYSTEMS in accordance with the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

One aspect of the invention pertains to the distribution of business cards. Typically, one provides business cards to persons, a “target,” to whom. Recent introductions have been made. When one provides a target with a business card it is difficult to know whether the target kept the card, lost the card, or chose to discard of it, unless of course the target contacts the business card distributor directly. Moreover, unless the target provides specific information about him or herself, the business card distributor has no way of knowing identifying information about the target even after subsequent contact. This is equally true for virtual business cards as for physical business cards. For clarity, it will be appreciated that virtual business cards may be transferred through any known or future technology, such as “tap” technology, text technology, or the like.

Through the present invention the target is incentivized to take action, and through this action identifying information about the target is relayed via a computer implemented beneficial system, for example a coupon system, to the business card distributor. Alternatively, or in addition, a third-party running the beneficial system may also be provided with the information.

One manner of incentivizing the target to take action is through a coupon system, such as The Hotel Card™ system. The Hotel Card™ is a trademark of Media Promotions International, LLC, 304 Indian Trace, Weston, Fla. 33326. It should be appreciated that through mere registration with the coupon system by the target, (s)he will receive a financial benefit in the form of a coupon. Upon this registration, information about the target is then conveyed to either or both of the business card distributor and/or a third-party coupon system provider, and may be used in the future for further advertising promotions, sale, or other means of monetization. Moreover, a real benefit is conveyed to the target through not only the initial coupon value, but through the ability to enhance the coupon value by paying for additional funding at a discounted rate. If the target does enhance the value of the coupon, a portion of the proceeds may be provided to the original business card distributor. Additionally, the provision of additional funds may act as a trigger to make available previously unavailable benefits. Additionally, the target can gift all or portions of the coupon value to others.

If the target him or herself registers for the coupon service and incentivizes others to join through the distribution of his or her own advertising materials, then the target may share revenue derived from those that they target with the original business card distributor that introduced the target to the coupon service. In this manner the original business card distributor can share revenue with many downstream targets, increasing value to all upstream participants.

To register with the coupon service the target merely scans a bar code, QE code, or the like, appearing on the advertising material and linked to the coupon service, with his or her handheld device enabled with any number of existing applications. Alternatively, an alphanumerical code may be entered into a website identified on the business card, or the target can download and utilize a specifically coded mobile application. Using these methods, the coupon service will be initiated and the target will then be prompted for the requisite identifying information and, upon provision, will be granted the coupon and alternatively the ability to increase the coupon's value.

It will also be appreciated that while business cards have been used as an example, this system can work with virtually any type of advertising medium and is particularly suitable for use in any location where persons have to wait for services. For example, the bar code or QR code (or alphanumeric code) may be placed on a menu at a restaurant, a placemat at a restaurant, an airline travel tray, or any other typical signage. Codes may also be placed on advertising materials such as mugs, clothing, water bottles, bags, and the like.

In one embodiment of the invention the process is shown in six steps.

In accordance with this embodiment, and as an example of how this system may operate, in a first step an advertiser orders business cards with a unique identification code. The business card also depicts a coupon value so the recipient will know the monetary benefit associated with that card. The unique identification code is preregistered into the benefits system so the advertiser's identity is known to the benefits system awaiting registration of recipients.

In a second step, the advertiser provides his business cards to recipients. This can be a personal provision, such as by a direct hand to hand provision of a business card, or the advertiser; may simply leave business cards in locations where persons may pick them up, such as on advertising boards at local establishments, restaurant placements, other persons, etc. An advertiser may also provide multiple business cards to a recipient for them to further disseminate.

In a third step, the business card recipient, sometimes referred to as the target, uses the unique code to log in to the computer implemented beneficial service system. During this registration process, the target provides certain identifying information about themselves in exchange for receiving the benefits. Such benefits may be in the form of restaurant savings, hotel savings, or other types of entertainment discounts such as discounts to theaters, attractions, and the like. The target is also offered the opportunity to purchase his or her own business cards with a separate unique identification code making the target a second level advertiser.

In a fourth step, the target's identifying information, or at least portions of it, is sent to the advertiser or otherwise made available to the advertiser in a location where the advertiser can retrieve the data, such as a database accessible by the advertiser. Preferably, this information includes at least the target's name and email address, but may include a variety of other information as discussed above. In one example, the information is also collected by the third-party benefits service company.

In a fifth step, the target receives a distinct code that provides tangible benefits at the third-party website, such as a saving card website. As an example, the benefit may include a dollar value which can be used toward the purchase of restaurant vouchers, hotel stays, services, attractions, and the like.

Finally, in the sixth step, the target again has the option to purchase his or her own business cards with unique identifying code.

During steps 3-6, the recipient may also be provided with the opportunity to reload additional funds into his or her account, adding to the funds provided by the advertiser. The system may be set up such that if the recipient does reload funds, additional benefits may become available. For example, it may have been that only vouchers for restaurants and attractions were initially available to the recipient. Upon reload, additional benefits such as services or hotel stay benefits may then be made available as an added incentive for the reload.

These additional benefits may operate under the same financial terms as previously, i.e. being essentially free to the recipient, or they may operate under different financial terms.

Moving though a more specific example, a real estate agent may purchase 500 business cards at a cost of $100. Each of the business cards may be inclusive of a code linked to a computer implemented beneficial service that the agent has preregistered to him or herself. The card itself will typically identify to the target the amount of the benefit, for example $25.

the real estate agent, may then hand out card #1 to a recipient, or target, he or she meets at his or her office. The real estate agent may also leave cards #2-10 with a bank loan officer whom that agent has a personal relation with. In this situation, the real estate agent knows that card #1 has been provided to a particular target but has little to no knowledge of effectiveness of cards #2-10. Up to now this is not unlike present business card advertising techniques.

However, under the present invention, if the recipients of cards #1-10 register their card with the third-party benefits system, the advertiser gains knowledge not only that the card has been seen (particularly in cases of cards #2-10), but the precise person who saw the card because he or she now has the recipients' identifying information.

That information can then be used for direct future advertisement, primarily in the form of targeted future email or mail solicitations. Moreover, because the target has received a financial benefit for receiving and registering the card, the recipient may be more likely to utilize the advertiser's services, in this case hiring the advertiser as the person's real estate agent.

Regarding targeted email solicitations, it is to be understood that once the advertiser obtains the name and email address of targets whom have registered with the benefits system (for example, and among other possible pieces of identifying information), the advertiser may at. its discretion, use this information for advertisement campaigns. These campaigns may be in the form of periodic emails offering the advertiser's services to all registered users. It may also target only those user's that have not availed themselves of the advertiser's services, or whom have not been contacted in a previous time period such as three months. Another option includes contacting only those recipients who have used the advertiser's services. Other virtually limitless options are or will also become readily available. Another option is to sell the data to third-party advertising companies for additional profit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined herein.

1. A marketing enhancement method comprising:
providing advertising material to a target, where the advertising material is inclusive of a code adapted to initiate a computer implemented beneficial service;
receiving identifying information about the target, including at least a name and email address, upon registration with the computer implemented beneficial service by the target.

2. The marketing enhancement method of claim 1, wherein the computer implemented beneficial service is a third-party beneficial service and a third-party beneficial service provider also receives the identifying information.

3. The marketing enhancement method of claim 1, wherein the code is a bar code or QR code.

4. The marketing enhancement method of claim 1, wherein the identifying information includes the target's name and email address.

5. The marketing enhancement method of claim 1, wherein the beneficial service is a coupon service.

6. The marketing enhancement method of claim 5, wherein the coupon service provides coupons for one of restaurants, theaters, attractions and services.

7. The marketing enhancement method of claim 1, wherein the advertising material is virtual advertising material.

8. The marketing enhancement method of claim 1, where the virtual advertising material is a virtual business card.

9. A marketing enhancement method comprising:
providing advertising material in the form of a business card to a target, the advertising material being Inclusive of a code linked to a computer implemented coupon service, the computer implemented coupon service being adapted to permit the target to register therewith by providing identifying information to a provider of the computer implemented coupon service;
automatically receiving the target's identifying information upon registration with the computer implemented coupon service by the target;
providing the target with a first coupon inclusive of a financial benefit for providing the identifying information to the computer implemented coupon service.

10. The marketing enhancement method of claim 9, further comprising permitting the target to add financially to the first coupon.

11. The marketing enhancement method of claim 9, wherein the business card is a virtual business card.

12. The marketing enhancement method of claim 9, wherein the previously unavailable coupons are made available under a different financial scheme from said first coupon.

13. The marketing enhancement method of claim 9, wherein the coupon service provides coupons for one of restaurants, theaters, attractions, and services.

14. The marketing enhancement method of claim 9, wherein the identifying information includes at least a name and email address of the target.

15. A marketing enhancement system comprising:
advertising material distributed by an advertiser and viewable by a target, where said advertising material is inclusive of a code operable to initiate a computer implemented beneficial service for registration by said target;
a computer readable medium associated with said computer implemented beneficial service, said computer readable medium comprising stored electronic data including, upon registration with the computer implemented coupon service by the target, identifying information about the target;
wherein said advertiser and an operator of said computer implemented coupon service receive said identifying information about the target.

16. The marketing enhancement system of claim 15, wherein said beneficial service is coupon service.

17. The marketing enhancement method of claim 15, wherein the business card is a virtual business card.

18. The marketing enhancement system of claim 15, wherein said identifying information includes at least name and email address.

19. The marketing enhancement system of claim 15, wherein said identifying information includes a mailing address.

20. The marketing enhancement system of claim 15, wherein said coupon service provides coupons for one of restaurants, theaters, attractions, and services.
